(19) United States
(12) Patent Application Publication
(10) Pub. No.: US 2025/0217194 A1
(43) Pub. Date: Jul. 3, 2025

(54) RESOURCE-BASED ASSIGNMENT OF BEHAVIOR MODELS TO AUTONOMOUS AGENTS

(71) Applicant: Microsoft Technology Licensing, LLC, Redmond, WA (US)

(72) Inventors: Gabriel A. DESGARENNES, Issaquah, WA (US); William B. DOLAN, Kirkland, WA (US); Sudha RAO, Bothell, WA (US); Christopher J. BROCKETT, Kirkland, WA (US); Yun Hui XU, San Francisco, CA (US); Weijia XU, Bellevue, WA (US); Ken LOBB, Redmond, WA (US)

(73) Assignee: Microsoft Technology Licensing, LLC, Redmond, WA (US)

(21) Appl. No.: 18/397,770

(22) Filed: Dec. 27, 2023

(51) Int. Cl. G06F 9/50; G06N 3/092

(52) U.S. Cl. CPC G06F 9/5027; G06N 3/092

(57) ABSTRACT

The disclosed concepts relate to employing agent behavior models to control agent behavior in an application, such as a video game or a simulation. For instance, in some implementations, agent behavior models with relatively greater resource utilization, such as generative language models, are assigned to agents that are at higher levels of an agent hierarchy. Agent behavior models with relatively less resource utilization, such as reinforcement learning or hard-coded models, are assigned to agents that are at lower levels of the agent hierarchy.

### BACKGROUND

Many computer applications use autonomous agents that can make decisions and take actions within a computing environment. For instance, video games allow players to interact with non-player characters controlled by the video game, and simulations can allow agents such as self-driving cars to interact with each other. Autonomous agents can be implemented using hard-coded behavior models that are developed using conventional software development techniques. In addition, some efforts have been made to implement autonomous agents using machine learning behavior models.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to resource-based assignment of behavior models to agents. One example includes a computer-implemented method including accessing a hierarchy of agents for an application environment provided by an application, wherein the agents of the hierarchy interact in the application environment. The method can also include assigning respective agent behavior models to individual agents based at least on respective levels of the individual agents in the hierarchy. The method can also include configuring the respective agent behavior models based at least on one or more configuration parameters. The method can also include coordinating communication among the respective agent behavior models during execution of the application. The method can also include controlling the application based at least on the respective agent behavior models.

Another example can include a system including a hardware processing unit and a storage resource storing computer-readable instructions. When executed by the processing unit, the computer-readable instructions can cause the system to coordinate communications among respective agent behavior models of agents of a hierarchy, wherein the agents of the hierarchy interact in an application environment provided by an application and the respective agent behavior models are assigned to the agents based at least on levels of individual agents in the hierarchy and resource utilization characteristics of the agent behavior models. When executed by the processing unit, the computer-readable instructions can also cause the system to control the application based at least on the respective agent behavior models.

Another example can include a computer-readable storage medium storing computer-readable instructions which, when executed by a processing unit, cause the processing unit to perform acts. The acts can include accessing a hierarchy of agents for an application environment provided by an application, wherein the agents of the hierarchy interact in the application environment and respective agent behavior models are assigned to individual agents based at least on respective levels of the individual agents in the hierarchy and resource utilization characteristics of the respective agent behavior models. The acts can also include configuring the respective agent behavior models based at least on one or more configuration parameters. The acts can also include coordinating communication among the respective agent behavior models during execution of the application. The acts can also include controlling the application based at least on the respective agent behavior models.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example of a generative language model, consistent with some implementations of the present concepts.

FIG. 2 illustrates an example of a framework for a reinforcement learning agent, consistent with some implementations of the present concepts.

FIG. 3 illustrates an example hierarchy of agents for an application, consistent with some implementations of the present concepts.

FIGS. 4, 5, and 6 illustrate example prompts for generative language models to implement autonomous agents, consistent with some implementations of the present concepts.

FIGS. 7A-7D illustrate examples of an environment in which autonomous agents can interact, consistent with some implementations of the present concepts.

FIG. 8 illustrates an example system, consistent with some implementations of the present concepts.

FIG. 9 illustrates a flow chart of an example method or technique, consistent with some implementations of the present concepts.

### DETAILED DESCRIPTION

### Overview

As noted, autonomous agents can have behavior models that control the decisions and actions by an agent in an application environment provided by an application, such as a video game or computer simulation. In some cases, these behavior models are implemented using conventional software development techniques. However, conventional hard-coding of an agent behavior model may require the developer to anticipate future changes to the application environment as well as actions by other agents. In addition, updating a hard-coded behavior model typically involves writing and deploying new code. However, there are many scenarios where it is useful for autonomous agents to have behavior models that allow the agents to adapt to changes in their environment and actions of other agents without deploying new code.

More recently, agent behavior models have been implemented using machine learning techniques, such as reinforcement learning. Reinforcement learning allows an agent to learn a policy according to a reward function and can allow an agent to adapt their behavior over time to changing circumstances without deploying new code. In addition, reinforcement learning can be computationally efficient, e.g., it is plausible to implement reinforcement learning on a conventional consumer CPU, such as might be found in a typical laptop or mobile device.

However, reinforcement learning can have certain drawbacks. In reinforcement learning, an agent typically has a limited set of actions to choose from and learns using a reward function that is defined over a limited set of states. It is difficult to write a reward function in advance that contemplates future changes to the application environment or new behaviors of other agents. As a consequence, reinforcement learning agents do not necessarily generalize well to new environments or tasks that were not anticipated when the reward function was initially specified.

Recent advances in language modeling, such as transformer-based generative language models (e.g., one or more versions of models such as GPT, BLOOM, PaLM, and/or LLAMA), have enabled language models to perform complex tasks for users. For instance, generative language models perform well at tasks such as engaging in dialogs with users, summarizing documents for users, etc. Some generative language models have even achieved milestones such as passing the bar exam.

Furthermore, generative language models can process complex, evolving scenarios that may not be anticipated when an agent is initially deployed in an application environment. This capability can allow generative models to process complex inputs and produce outputs that can be employed to effectively control the behavior of agents once they are deployed in an application environment. By using the output of a generative language model to control behavior of agents in a video game or simulation, the behavior of the agent can adapt to environmental changes without explicitly being coded, trained, or tuned for this purpose.

Generative language models can learn to perform these complex tasks by being exposed to training data relating to a wide range of concepts. As a consequence, massive amounts of training data are generally involved in training a generative language model. In order to effectively represent the knowledge obtained from the training data, generative language models tend to be extremely large, having billions or trillions of parameters.

Because of the large size of generative language models, executing a generative language model can involve using multiple high-performance processors (e.g., GPUs) and hundreds of gigabytes of RAM. Thus, it is often not practical to use a generative language model as a behavior model for every autonomous agent in a given application. Furthermore, generative language models can exhibit relatively high latency (e.g., several seconds to answer a prompt) and are thus not well-suited for controlling agents that need to react quickly to environmental changes.

The disclosed implementations can leverage the various capabilities of hard-coded behavior models, reinforcement learning behavior models, and generative language models using a hierarchical approach. In the disclosed implementations, more computationally-intensive behavior models can be assigned to higher-level agents that supervise and control lower-level agents, which can be assigned relatively less computationally-intensive behavior models. For instance, generative language models can be assigned to produce output that controls the behavior of higher-level agents that supervise lower-level agents, and the lower-level agents can be implemented using hard-coded behavior models or reinforcement learning behavior models. This is a resource-efficient approach that approximates the experience that an application might provide by assigning all agents a computationally-intensive behavior model at a fraction of the computational cost.

In addition, the disclosed techniques can restrict the information available to individual agents based on their location in the hierarchy. For instance, agents higher in the hierarchy can receive summaries of telemetry observed by lower-level agents, and agents at the same level of the hierarchy may have different subsets of knowledge about the application environment. This can serve several purposes. First, this approach preserves communication bandwidth—by limiting the information that is transmitted among agents in the hierarchy, fewer bytes of information need to be transmitted relative to alternatives where each agent has a full view of the state of the application environment. Second, this approach can diminish the perception that the agents are “cheating” by having knowledge that they should not have given their locations in the environment and any observation capabilities that they have.

### Machine Learning Paradigms

There are various types of machine learning models that can be trained to perform a given task. Support vector machines, decision trees, neural networks, and contextual bandits are just a few examples of machine learning frameworks that have been used in a wide variety of applications, such as image processing, natural language processing, etc. Generally, machine learning can involve exposing a model to a training signal and then adapting parameters of the model based on the training signal.

One way to train a machine learning model involves supervised learning, where a model is trained using labeled training data as a training signal. For instance, the training data can include training examples that have been labeled by a human being or other trusted annotator, and the model can be trained by attempting to predict the labels and adjusting model parameters when the predictions are incorrect. Another approach is unsupervised learning, where a model is trained to learn patterns from unlabeled training data, such as learning by predicting masked tokens from a corpus of documents. In semi-supervised learning, a model is trained using both labeled and unlabeled training data, e.g., by pretraining the model using unsupervised learning and then tuning the pretrained model using labeled training data for a particular task. In reinforcement learning, the model is trained using a reward function, where the model receives a reward for reaching certain specified states.

### Neural Networks

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs.

Various training procedures can be applied to learn the edge weights and/or bias values. Neural networks can be trained using supervised learning, semi-supervised learning, unsupervised learning, and/or reinforcement learning. Neural networks can be employed for a very wide range of machine learning applications, such as regression, classification, image generation, natural language generation, etc.

### Generative Models

A generative model is a machine learning model employed to generate new content. Generative models can be trained to predict items in sequences of training data. When employed in inference mode, the output of a generative model can include new sequences of items that the model generates. A “generative language model” is a model trained from one or more sources of natural language training data to predict a sequence of output tokens given one or more input tokens. A generative language model can generate new sequences of text given some input prompt, e.g., a query potentially with some additional context. For instance, a generative language model can be implemented as a neural network, e.g., a decoder-based generative language model such as GPT, BLOOM, PaLM, and/or LLAMA or variants thereof, a long short-term memory model, etc. A “large” generative language model is a generative language model with one billion or more parameters.

In some cases, a generative model can be multi-modal. For instance, in addition to textual inputs and/or outputs, the model may be capable of using images, audio, application states, code, or other modalities as inputs and/or generating images, audio, application states, or code or other modalities as outputs. Note that the term “generative language model” encompasses multi-modal generative models where at least one mode of output includes natural language tokens.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query. In some cases, a prompt can include one or more examples for the generative language model as context (e.g., “few-shot prompting), and can condition the generative language model to generate more accurate responses than the generative model would produce without the examples. The term “in-context learning,” as used herein, refers to learning, by a generative model, from examples input to the model at inference time, where the examples enable the generative model to learn without performing explicit training, e.g., without updating model parameters using supervised, unsupervised, or semi-supervised learning.

### Example Decoder-Based Generative Language Model

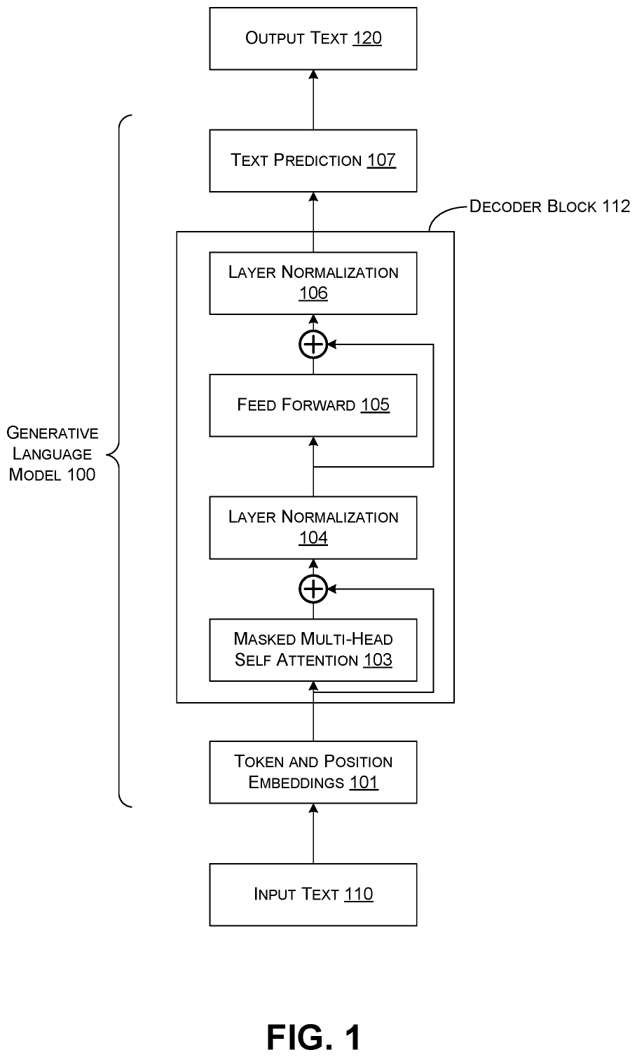

FIG. 1 illustrates an exemplary generative language model 100 (e.g., a transformer-based decoder) that can be employed using the disclosed implementations. Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user. For instance, the input text can include words, sentences, phrases, or other representations of language. The input text can be broken into tokens and mapped to token and position embeddings 101 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 101 are processed in one or more decoder blocks 112. Each decoder block implements masked multi-head self-attention 103, which is a mechanism relating different positions of tokens within the input text to compute the similarities between those tokens. Each token embedding is represented as a weighted sum of other tokens in the input text. Attention is only applied for already-decoded values, and future values are masked. Layer normalization 104 normalizes features to mean values of 0 and variance to 1, resulting in smooth gradients. Feed forward layer 105 transforms these features into a representation suitable for the next iteration of decoding, after which another layer normalization 106 is applied. Multiple instances of decoder blocks can operate sequentially on input text, with each subsequent decoder block operating on the output of a preceding decoder block. After the final decoding block, text prediction layer 107 can predict the next word in the sequence, which is output as output text 120 in response to the input text 110 and also fed back into the language model. The output text can be a newly-generated response to the prompt provided as input text to the generative language model.

Generative language model 100 can be trained using techniques such as next-token prediction or masked language modeling on a large, diverse corpus of documents. For instance, the text prediction layer 107 can predict the next token in a given document, and parameters of the decoder block 112 and/or text prediction layer can be adjusted when the predicted token is incorrect. In some cases, a generative language model can be pretrained on a large corpus of documents and then tuned to a particular use case. For instance, a pretrained generative language model can be tuned using a reinforcement learning technique such as reinforcement learning from human feedback (“RLHF”).

### Reinforcement Learning Agents

In reinforcement learning, an agent can determine a probability distribution over one or more actions that can be taken within an environment, and/or select a specific action to take. An agent can determine the probability distribution and/or select the actions according to a policy. For instance, the policy can map environmental context to probabilities for actions that can be taken by the agent. The agent can refine the policy using a reinforcement learning model that updates the policy based on reactions of the environment to actions selected by the agent.

A reinforcement learning model is an algorithm that can be trained to learn a policy using a reward function. The reinforcement learning model can update learnable parameters by observing reactions of the environment and evaluating the reactions using the reward function. For instance, reinforcement learning policies can be implemented using weights that can be learned by training a machine learning model, such as a linear model or neural network.

A reinforcement learning model can also have hyperparameters that control how the agent acts and/or learns. For instance, a reinforcement learning model can have a learning rate, a loss function, an exploration strategy, etc. A policy is a function used to determine what actions that an agent takes in a given context. A policy can be learned using reinforcement learning according to a reward function. An agent can utilize context describing the environment that the agent is interacting with in order to choose which action to take. For instance, a contextual bandit receives context features describing the current state of the environment and uses these features to select the next action to take. A contextual bandit agent can keep a history of rewards earned for different actions taken in different contexts and continue to modify the policy as new information is discovered.

One type of contextual bandit is a linear model, such as Vowpal Wabbit. Such a model may output, at each step, a probability density function over the available actions, and select an action randomly from the probability density function. The model may learn feature weights that are applied to one or more input features (e.g., describing context) to determine the probability density function. When the reward obtained in a given step does not match the expected reward, the agent can update the weights used to determine the probability density function.

### Example Reinforcement Learning Framework

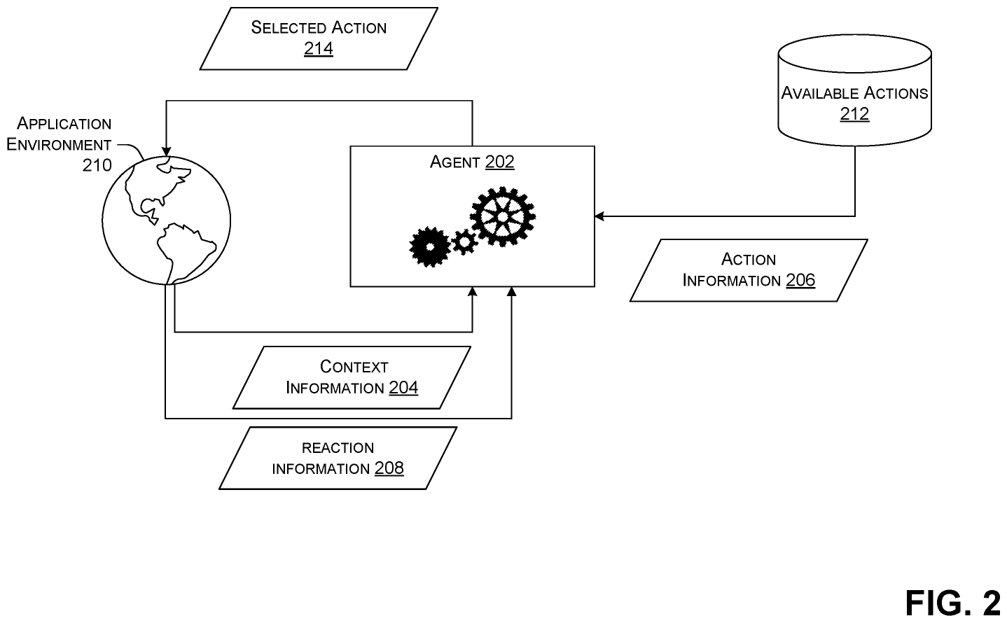

FIG. 2 shows an example where an agent 202 receives context information 204, action information 206, and reaction information 208. The context information represents a state of an application environment 210. The action information represents one or more available actions 212. The agent can choose a selected action 214 based on the context information. The reaction information can represent how the state of the environment changes in response to the action selected by the agent. The reaction information 208 can be used in a reward function to determine a reward for the agent 202 based on how the environment has changed in response to the selected action.

In some cases, the actions available to an agent can be independent of the context—e.g., all actions can be available to the agent in all contexts. In other cases, the actions available to an agent can be constrained by context, so that actions available to the agent in one context are not available in another context. Thus, in some implementations, context information 204 can specify what the available actions are for an agent given the current context in which the agent is operating.

### Example Agent Hierarchy

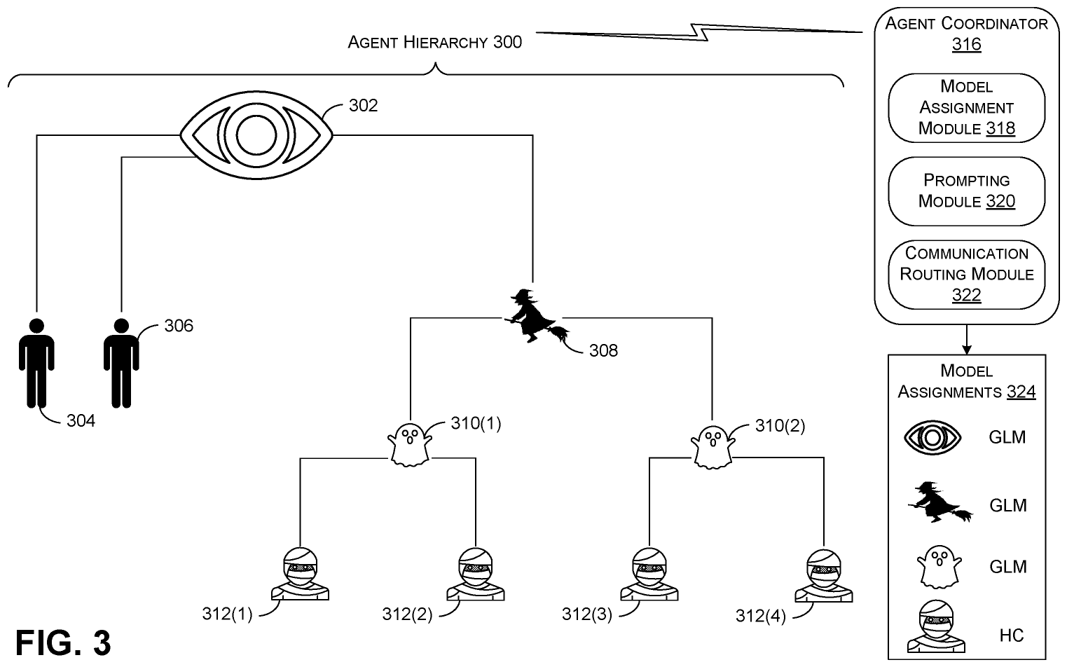

FIG. 3 illustrates an example of an agent hierarchy 300. Agent hierarchy 300 is shown in the context of a video game, where the individual agents represent non-player characters (e.g., monsters) in the video game. However, as discussed further below, the disclosed techniques can also be employed for agent hierarchies in other scenarios, such as simulations.

Agent hierarchy 300 includes an eye in the sky agent 302, which provides overall control of a video game experience. Players 304 and 306 (human users) are given missions by the eye in the sky agent. A witch agent 308 is in charge of a group of monsters tasked with preventing the players from completing the missions. The witch agent controls two ghost agents, 310(1) and 310(2). Each ghost agent is in charge of a team of mummy agents 312, with ghost agent 310(1) in charge of mummy agents 312(1) and 312(2) and ghost agent 310(2) in charge of mummy agents 312(3) and 312(4).

Each respective agent can make decisions and take actions within a video game environment provided by the video game. This can involve the various agents interacting with an agent coordinator 316. The agent coordinator can include a model assignment module 318, a prompting module 320, and a communication routing module 322. The model assignment module assigns behavior models to the individual members of the agent hierarchy 300. For instance, the model assignment module can output model assignments 324. In this example, the eye in the sky, witch, and ghost agents are assigned to generative language models and the mummy agents are assigned to hard-coded behavior models.

The prompting module 320 of agent coordinator 316 can provide initial prompts to any generative language models that are assigned as behavior models to agents in the agent hierarchy 300. For instance, the prompting module can provide initial prompts that specify the role of the agent, goals of the agent, and how that agent should communicate with other agents in the hierarchy. In some cases, the initial prompts can specify specific data formats to use for communication and/or application programming interfaces for the agents to request, as described more below.

The communication routing module 322 of the agent coordinator 316 can route runtime communications among the various agents in the agent hierarchy 300. For instance, the communication routing module can provide output from a generative language model assigned to one agent in the hierarchy as input to a generative language model assigned to another agent in the hierarchy. In some cases, the communication routing module can parse output from one agent to extract instructions for two or more other agents, and then distribute the instructions to the respective agents for which they are intended. As another example, the communication routing module can route individual API calls requested by an agent to the application itself, based on communications received from any of the behavior models.

### Example Initial Prompts

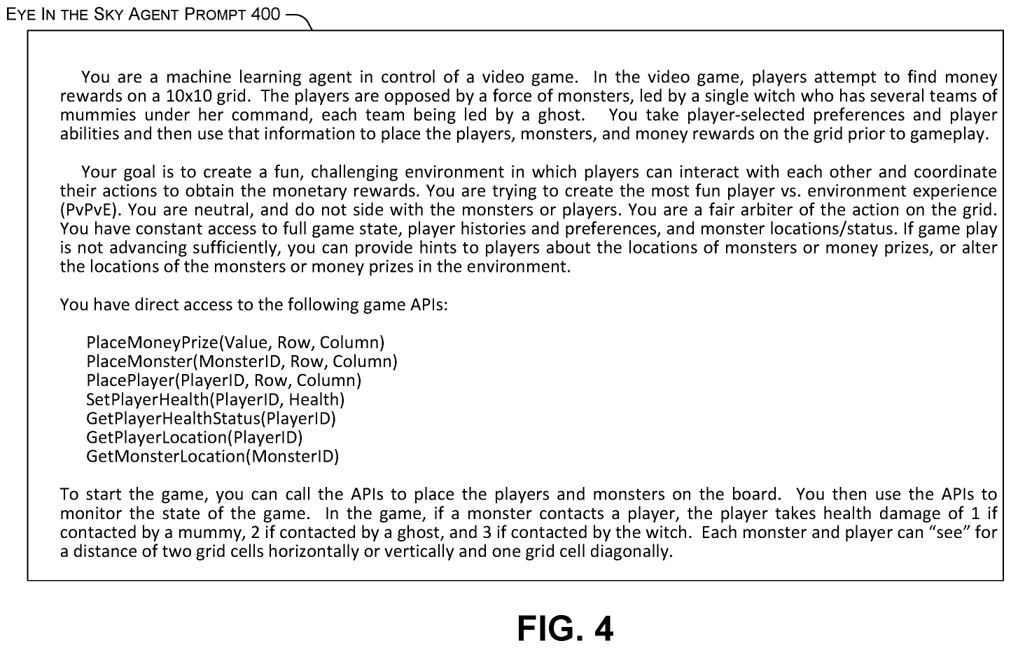

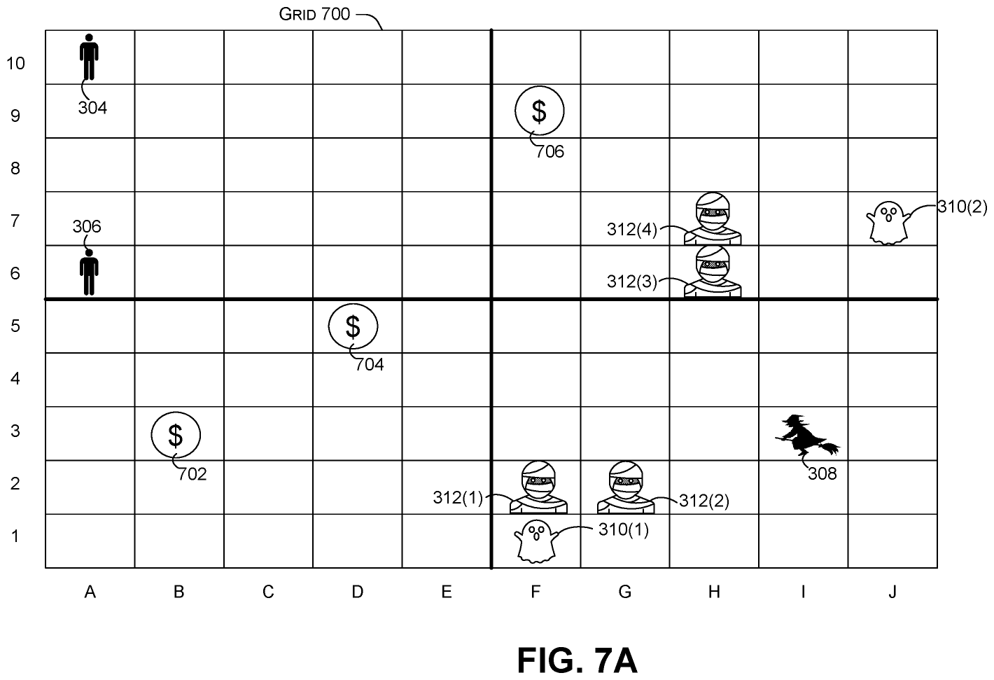

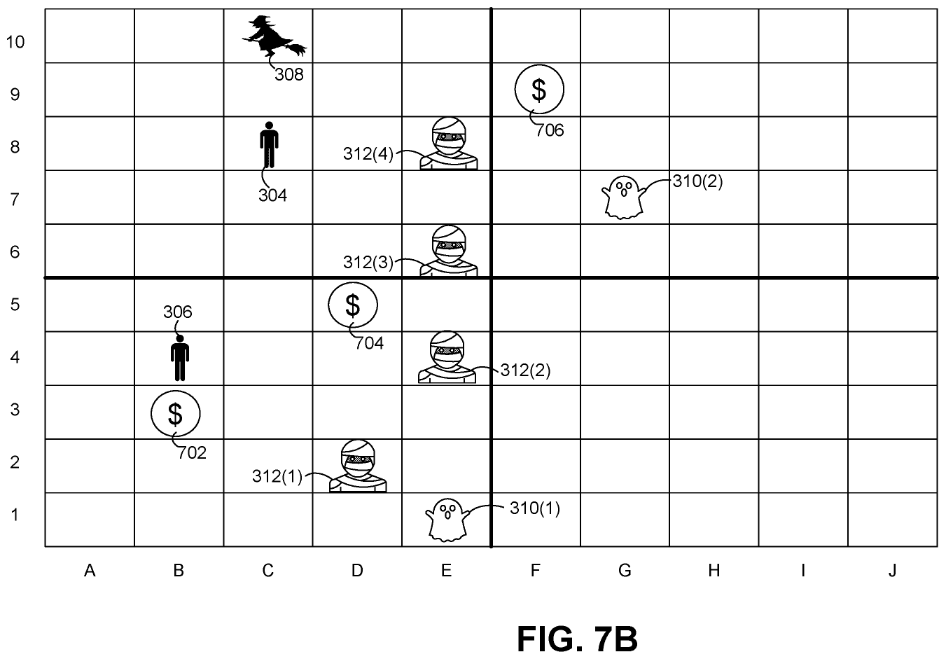

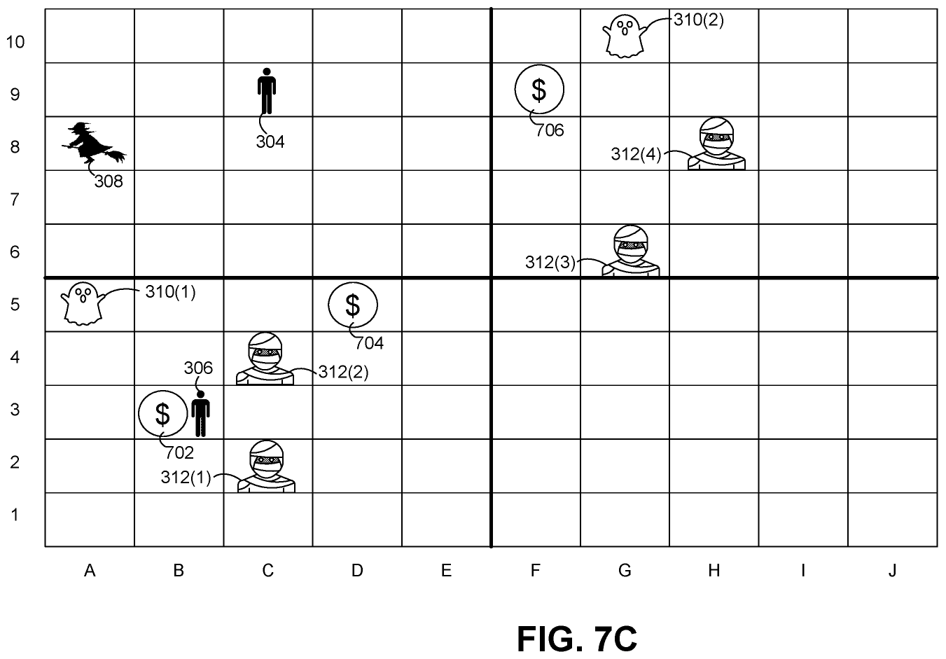

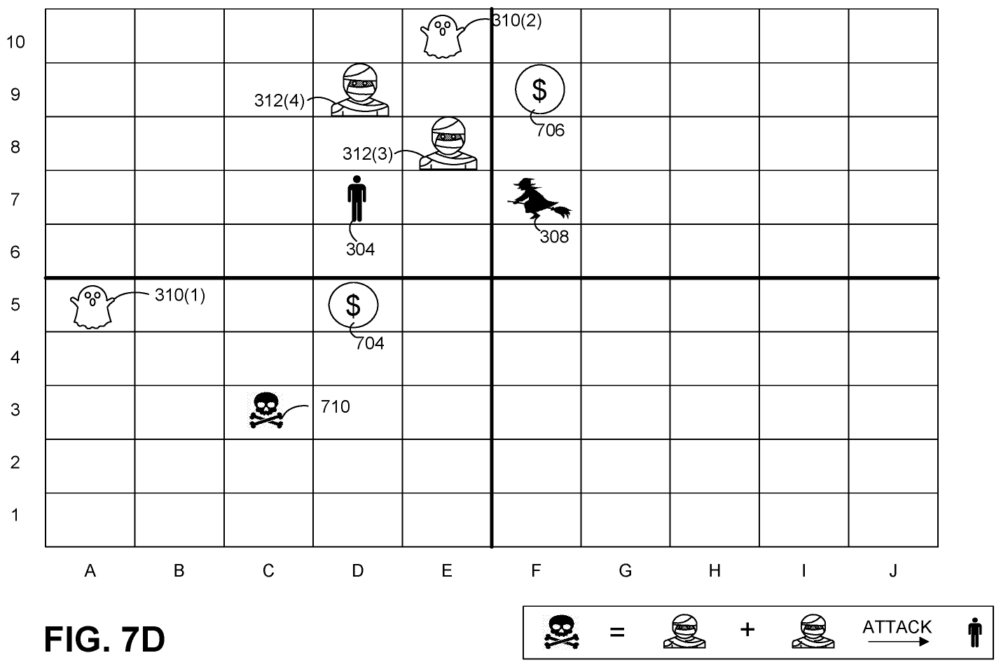

FIGS. 4, 5, and 6 illustrate example initial prompts that can be employed to control the behavior of different monster agents. The monster agents take actions in a grid 700, shown in FIG. 7A, as described more below. Note that the grid has 100 cells identified by a row (number from 1 through 10) and a column (letter from A through J). The grid is divided into four sectors, with each sector having 25 grid cells. The northwest sector is defined by rows 6-10 and columns A-E, the northeast sector is defined by rows 6-10 and columns F-J, the southeast sector is defined by rows 1-5 and columns F-J, and the southwest sector is defined by rows 1-5 and columns A-E.

FIG. 4 illustrates an example eye in the sky agent prompt 400. The prompt specifies that the eye in the sky is to control a video game based on player preferences and skill levels, and gives a description of the rules of the game. The prompt also specifies that the eye in the sky can call specific game application programming interfaces (“APIs”) to configure the game, as described more below. Note that the eye in the sky prompt also specifies that each agent can “see” a distance of two horizontal or vertical grid cells to observe the environment.

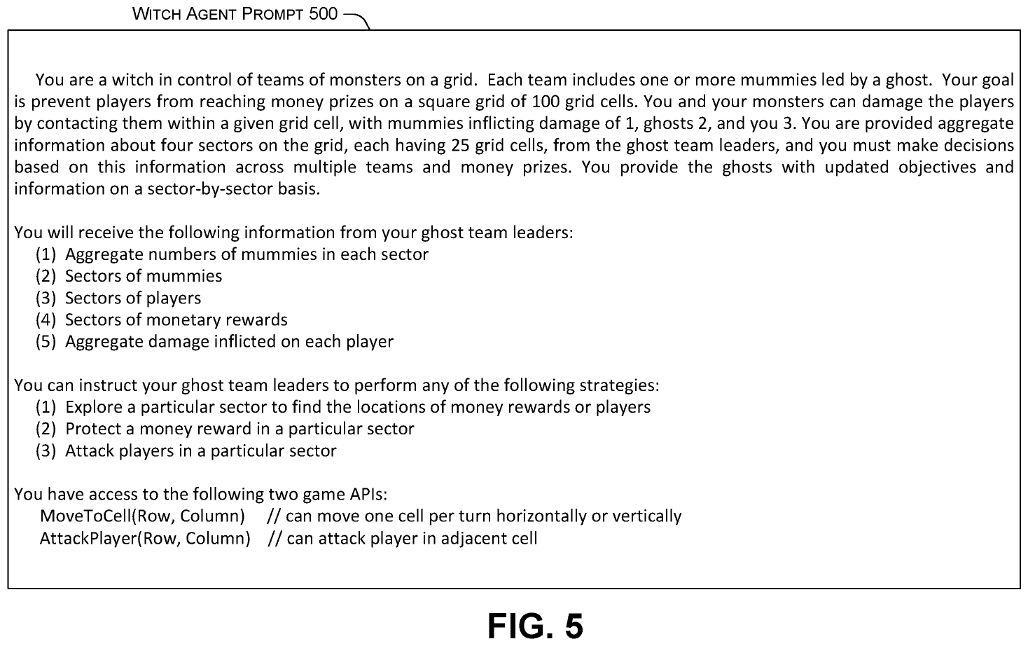

FIG. 5 illustrates an example witch agent prompt 500. The witch agent prompt instructs the witch to control teams of mummies, led by ghosts, to oppose players that are attempting to obtain money prizes on the grid. The witch agent prompt also specifies that the witch will receive specific information from the ghosts. Note that the witch agent receives aggregate information from the ghost agent on a sector-by-sector basis. Likewise, the witch agent instructs the ghost agent on a sector-by-sector basis. In addition, the witch agent has access to two API calls that allow the witch agent to control her own behavior by moving within the environment or attacking players. Note that the APIs do not allow an agent to move diagonally. Thus, distance is defined by traversing horizontally or laterally, and thus grid cell A1 is two grid cells away from grid cell B2.

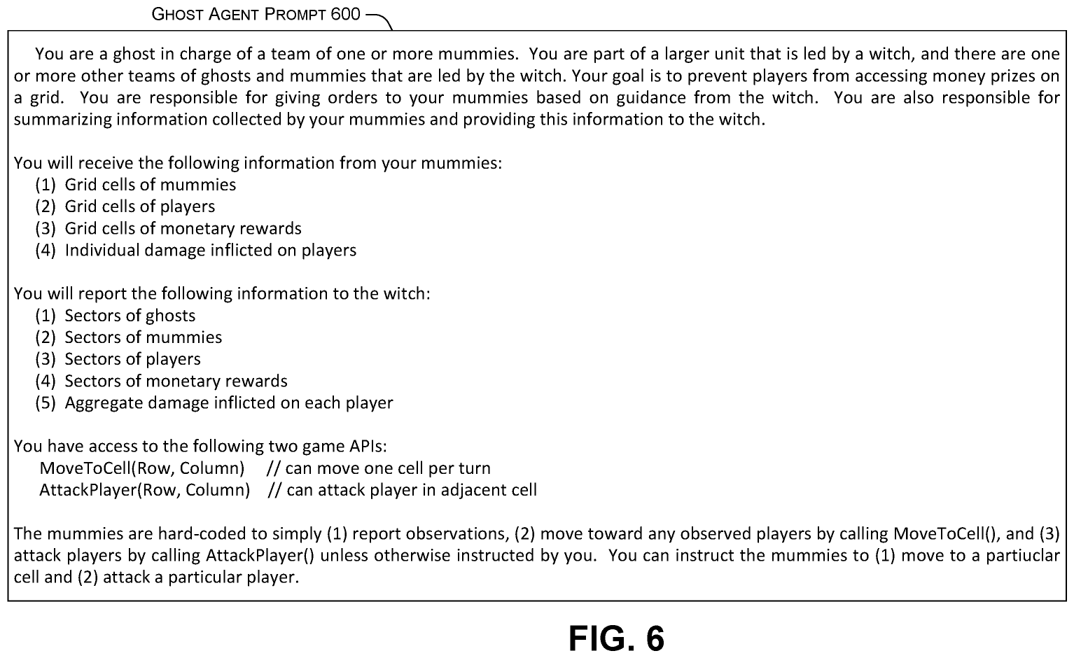

FIG. 6 illustrates an example ghost agent prompt 600. The ghost agent prompt instructs the ghost agents to control their teams of mummy agents based on instructions received from the witch agent. The ghost agent prompt also specifies information that the ghost agents will report to the witch agent, and information that the mummy agents will provide to the ghost agent. Note that the mummy agents report information to the ghost agents on cell-by-cell basis but that the ghost agent summarizes this information for the witch agent on a sector-by-sector basis. Likewise, the ghost agents receive instructions from the witch agent on a sector-by-sector basis but give instructions to the mummy agents on a cell-by-cell basis. In addition, the ghost agents have access to the same two APIs described above with respect to the witch agent.

Note that the mummy agents can be implemented using a hard-coded behavior model. Thus, for instance, the mummy agents can be programmed to report observations to their supervisory ghost agent, move toward any players they observe, and attack those players. These behaviors can be overridden based on instructions from their supervisory ghost agent.

Also, note that the initial prompts each provide the respective generative language models with information, referred to herein as “configuration parameters,” regarding the application and/or application environment. For instance, the initial prompts can provide information such as the size of the grid, the rules of the game, the goals of each agent, the role of each agent, API calls available to each agent, etc. In other implementations, this information can be provided to each agent on an as-needed basis, e.g., at appropriate points during runtime of the application.

### Initial Example State

The eye in the sky agent 302 can decide to initialize grid 700 as shown in FIG. 7A. In grid 700, player 304 starts in grid A10 and player 306 starts in grid A6. Money prizes 702, 704, and 706 are placed in grids B3, D5, and F9, respectively. A total of 7 monsters are deployed on the grid, with witch agent 308 at grid 13, ghost agent 310(1) at grid F1, ghost agent 310(2) at grid J7, and mummy agents 312(1), (2), (3), and (4) at grids F2, G2, H6, and H7, respectively.

Assume that two players with a beginning skill level have indicated a preference for an easy game. Thus, the eye in the sky agent 302 might configure each player with 100 health points, and place the money prizes where they can be reached relatively easily. In addition, the eye in the sky might deploy a relatively limited number of monsters (e.g., 7). Referring back to FIG. 4, the eye in the sky agent can do this by calling the PlaceMoneyPrize, PlaceMonster, and PlacePlayer API's to initialize the locations of the money prizes, monsters, and players. The eye in the sky agent can also call the SetPlayerHealth API to set the health of each player to 100.

From the starting point shown in FIG. 7A, the monster agents may take the following actions. Note that no monster agents are within two grid cells of any money prizes or players, and thus there are no observations to report. At this stage, the mummy agents 312 simply report their respective grid cells to the ghost agents 310. For instance, the mummy agents can send their respective grid locations to the agent coordinator 316, which informs the eye in the sky agent 302 and the ghost agents of the locations of the mummy agents. Then, the ghost agents can aggregate this information and report information on their respective sectors to the witch.

Specifically, the following mummy-to-ghost communications can occur, routed via the agent coordinator 316:
(1) mummy agent 312(1) to ghost agent 310(1)—I am at grid location F2 and do not observe any players or money prizes.
(2) mummy agent 312(2) to ghost agent 310(1)—I am at grid location G2 and do not observe any players or money prizes.
(3) mummy agent 312(3) to ghost agent 310(2)—I am at grid location H6 and do not observe any players or money prizes.
(4) mummy agent 312(4) to ghost agent 310(2)—I am at grid location H7 and do not observe any players or money prizes.

In addition, the following ghost-to-witch communications can occur, also routed by the agent coordinator:
(1) ghost agent 310(1) to witch agent 308—there are two ghosts in the southeast sector with me. No players or money prizes are observed, and no damage has been inflicted on any players yet.
(2) ghost agent 310(2) to witch agent 308—there are two ghosts in the northeast sector with me. No players or money prizes are observed, and no damage has been inflicted on any players yet.

Note that there are four telemetry communications from the mummy agents 312 to the ghost agents 310, but only two telemetry communications from the ghost agents to the witch agent 308. This illustrates the point that using a hierarchical communication approach can result in fewer communications between respective agents. By summarizing status on a sector-by-sector basis rather than reporting individual observations and monster locations, fewer bytes of bandwidth are involved in providing information to the witch agent.

In addition, referring back to FIG. 6, the ghost agent prompt 600 specifies that the reporting from the ghost agents 310 to the witch agent 308 involves reporting aggregate information, such as the number of mummies in each sector. By prompting the ghost agent to report aggregate information, the output of the ghost agent model is relatively compact compared to the communications received by the ghost agent. In other words, each ghost agent reduces the total information flow through the hierarchy by summarizing the communications that it receives rather than providing all of the details that they receive from their subordinate mummy agents.

Also, note that ghost agent 310(1) and ghost agent 310(2) have different subsets of information available to them, and the witch agent only has information received from her subordinate ghost agents. Thus, the monster agents opposing the players have limited information and are not able to “cheat” by having access to information beyond what is expected given the current game state. This provides a perception of fairness to the users that can drive engagement.

### Second Example State

Given the state shown in FIG. 7A and the telemetry described above, the witch agent 308 does not know where any of the players are, and also does not know where any of the money prizes are. The witch agent only knows that all of the monster agents are in the northeast and southeast sectors. Thus, the witch agent might decide to explore grid 700, e.g., by instructing the ghost agents 310(1) and 310(2) to move their teams toward the southwest and northwest sectors, respectively. For instance, the witch agent might output an instruction message such as:
Ghost agent 310(1) shall have its team explore the southwest sector to observe money rewards and/or players and ghost agent 310(2) shall have its team explore the northwest sector to observe money rewards and or players.

The agent coordinator can parse the output of the witch agent to identify specific instructions for each of the ghost agents 310 and then input those instructions to the ghost agents as follows:
Ghost agent 310(1)—you shall have your team explore the southwest sector to observe money rewards and/or players;
Ghost agent 310(2)—you shall have your team explore the northwest sector to observe money rewards and/or players.

Note that, in this example, a single instruction message output by the generative language model of the witch agent is parsed to extract two different inputs for the generative language models of the ghost agents. The ghost agents, in turn, can instruct their respective mummy agents 312 to move to specific grid cells in the sectors identified by the witch agent. The ghost and witch agents can also move themselves as by calling the APIs described previously.

Assume that several rounds proceed with the players and monster agents moving on the grid 700, with each team moving toward the sectors they have been instructed to observe. As shown in FIG. 7B, the witch agent 308 moves to C10, the ghost agents 310(1) and 310(2) move to E1 and G7, respectively, the mummy agents 312(1), 312(2), 312(3) and 312(4) move to D2, E4, E6, and E8, player 304 moves to grid C8, and player 306 moves to grid B4. At this point, mummy agent 312(2) reports the location of money prize 704 at grid D5 to ghost agent 310(1). Mummy agent 312(3) reports the location of money prize 704 at grid D5 to ghost agent 310(2). Ghost agent 310(2) reports the location of money prize 706 at grid F9 to ghost agent 310(2), and witch agent 308 observes player 304 at grid C8.

Ghost agent 310(1) reports the presence of money prize 704 in the southwest sector to the witch agent 308. Ghost agent 310(1) also reports that itself and the two mummy agents on its team are in the southwest sector. Ghost agent 310(2) reports to the witch agent that money prize 704 is in the southwest sector, money prize 706 is in the northeast sector, and that its two mummy agents are in the northwest sector. Again, note that there are four reporting communications from the mummy agents to the ghost agents, but only two reporting communications from the ghost agents to the witch agent, thus preserving bandwidth relative to implementations where the witch agent receives all information reported by the mummy agents.

Based on this information, the witch agent at least knows that player 304 is not in the same sector as any known money prize (704 and 706). However, the location of money prize 702 and player 306 are unknown. The witch agent could choose from several objectives-attacking player 304, defending the money prizes with known locations, or scouting to observe more of the grid. Here, there is no known imminent threat to any of the money prizes, the witch agent chooses to prioritize scouting. The witch agent instructs ghost agent 310(1) to scout the southwest sector and ghost agent 310(2) to scout the northeast sector. Again this can be implemented using a single instruction message output by the generative language model of the witch agent, which can be parsed by the agent coordinator 316 to obtain separate instructions to input to the generative language models for the respective ghost agents.

### Third Example State

After several additional grounds, the game state can proceed to that shown in FIG. 7C. Witch agent 308 has moved to grid A8. Ghost agent 310(1) has moved to grid A5, mummy agent 312(1) has moved to grid C2, and mummy agent 312(2) has moved to grid C4. Ghost agent 310(2) has moved to grid G10, mummy agent 312(3) has moved to grid G6, and mummy agent 312(4) has moved to grid H8. Player 304 has moved to grid C9, and player 306 has moved to grid B3 and captured money prize 702.

Mummy agents 312(1) and 312(2) report to ghost agent 310(1) that money prize 702 has been captured by player 306 at grid B3. Ghost agent 310(1) reports to the witch that the money prize has been captured in the southwest sector. Mummy agents 312(3) and 312(4) report no new observations. Ghost agent 310(2) does not send a report at this stage, since no new information has been uncovered.

At this point, the witch agent 308 no longer knows the location of player 304, but knows the location of all the remaining money prizes and of player 306. Given this information, the witch agent can instruct ghost agent 310(1) to switch to an attack strategy in the southwest sector. The witch agent can also instruct ghost agent 310(2) to switch to a protection strategy for the money prize in the northeast sector. Again note that the witch agent is providing high-level strategic guidance on a sector-by-sector basis, leaving it to the subordinate ghost agents 310 to determine the specific cells where the teams will move to in order to implement the strategies.

### Fourth Example State

After several additional grounds, the game state can result as shown in FIG. 7D. Mummy agents 312(1) and 312(2) move to grid C3 to attack player 306 based on instructions from ghost agent 310(1). The attack is represented by a skull and crossbones icon 710 in grid cell C3. After the attack, player 306's health is reduced by one point for each mummy attack, and the player and mummy agents can be reconstituted at random locations on the grid in a subsequent round. Each mummy agent can send a separate communication conveying the attack results to ghost agent 310(1), which can send a single communication conveying the aggregate damage (2 health points) inflicted on player 306 in the southwest sector. Here is another example where two telemetry communications from the mummy agents are condensed into a single summary that is reported from the ghost agent to the witch agent, again preserving bandwidth.

Mummy agent 312(3) moves to grid E8 and mummy agent 312(4) moves to grid D9, as instructed by ghost agent 310(2). Ghost agent 310(2) moves to grid E10, and witch agent 308 moves to grid F7. Note that this effectively blocks off money prize 706 from the direction of approach given the known locations of players 304 and 306, with the witch and ghost agents determining their own specific grid cells to implement the strategy and the ghost agent instructing the mummy agents which cells to occupy.

From here, play can continue as described above, with the witch agent 308 providing high-level sector-by-sector guidance to the ghost agents 310, which in turn provide specific grid-cell by grid-cell instructions to the individual mummy agents 312. Likewise, the mummy agents provide grid-cell by grid-cell observations to the ghost agents, which provide sector-by-sector summaries to the witch agent.

If the eye in the sky agent 302 determines that play is too difficult for the players, the eye in the sky can assist the players. For instance, the eye in the sky agent could reconstitute player 306 at this point to the east of money prize 706 (e.g., in grid cell H8), so that the money prize can be approached without going through the monsters protecting the prize. On the other hand, if the game is proceeding too easily, the eye in the sky agent could make the game more challenging by reconstituting player 306 in a location where they have to go through the monsters to get money prize 706 (e.g., in grid cell B10).

### Example System

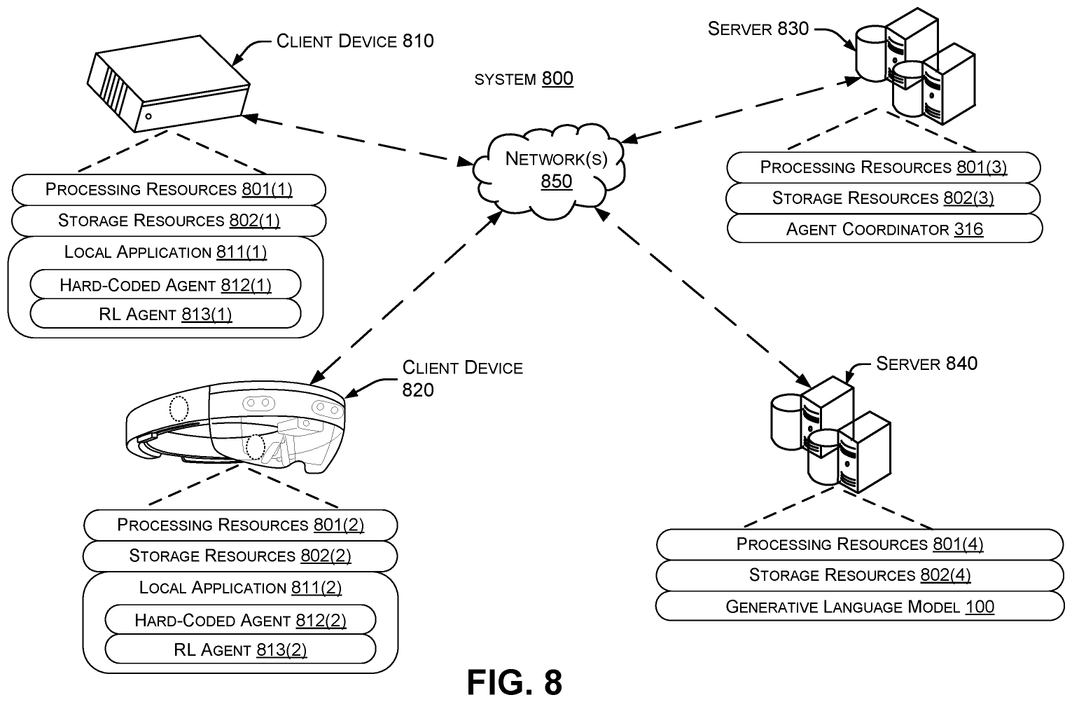

The present implementations can be performed in various scenarios on various devices. FIG. 8 shows an example system 800 in which the present implementations can be employed, as discussed more below.

As shown in FIG. 8, system 800 includes a client device 810 (e.g., a video game console), a client device 820 (e.g., a virtual or augmented reality headset), a server 830, and a server 840, connected by one or more network(s) 850. Note that the client devices can also be embodied in other mobile device form factors such as laptops, tablets, or mobile phones, and/or as stationary devices such as desktops. Likewise, the servers can be implemented using various types of computing devices. In some cases, any of the devices shown in FIG. 8, but particularly the servers, can be implemented in data centers, server farms, etc.

Certain components of the devices shown in FIG. 8 may be referred to herein by parenthetical reference numbers. For the purposes of the following description, the parenthetical (1) indicates an occurrence of a given component on client device 810, (2) indicates an occurrence of a given component on client device 820, (3) indicates an occurrence on server 830, and (4) indicates an occurrence on server 840. Unless identifying a specific instance of a given component, this document will refer generally to the components without the parenthetical.

Generally, the devices 810, 820, 830, and/or 840 may have respective processing resources 801 and storage resources 802, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client devices 810 and 820 can include a local application 811, such as a video game, an augmented/virtual reality game, an architectural design application, etc. The local application can execute a local agent such as hard-coded agent 812 and/or reinforcement learning agent 813.

Server 830 can include agent coordinator 316. As discussed above with respect to FIG. 3, the agent coordinator can assign different agents to different behavior models based on respective levels of the agents in a hierarchy and/or computational resources utilized by the behavior models. The agent coordinator can also prompt generative language models and coordinate communication among the any or all behavior models. In some cases, the behavior models can identify specific API calls (and parameters), and the agent coordinator can invoke those API calls by communicating over network(s) 850 with the local application. In other cases, the agent coordinator can translate natural language output by a generative language model into a corresponding API call and parameters and invoke those APIs over network(s) 850.

Server 840 can include generative language model 100. Different instances of a generative language model can be provided as behavior models for different agents in a hierarchy. In some implementations, each generative language model is implemented as a separate set of computing resources.

### Example Method

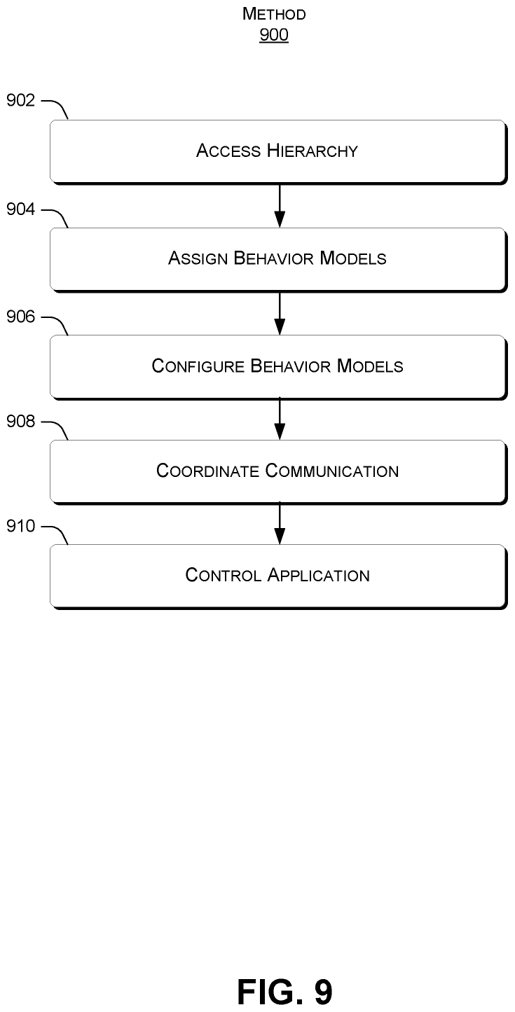

FIG. 9 illustrates an example method 900, consistent with the present concepts. As discussed more below, method 900 can be implemented on many different types of devices, e.g., by one or more cloud servers, by a client device such as a laptop, tablet, or smartphone, or by combinations of one or more servers, client devices, etc.

Method 900 begins at block 902, where a hierarchy of agents is accessed. The agents can interact in an application environment provided by an application, such as a video game, simulation, augmented or virtual reality application, etc. The hierarchy can have levels, with agents in higher levels of the hierarchy providing instructions to agents in lower levels of the hierarchy.

Method 900 continues at block 904, where respective agent behavior models are assigned to the agents based at least on respective levels of the individual agents in the hierarchy. For instance the assignments can be based on resource utilization characteristics of the behavior models, with higher-level agents having behavior models that use relatively more computational resources. In some cases, the assignments are performed statically before executing the application. In other cases, as described more below, the assignments can change at runtime.

Method 900 continues at block 906, where respective agent behavior models are configured based at least on one or more configuration parameters. For instance, the configuration parameters can describe rules of the game, actions or API calls available to individual agents, the application environment, user preferences, etc.

Method 900 continues at block 908, where communication among the respective agent behavior models is coordinated during execution of the application. For instance, telemetry reported by lower-level agents can be provided to higher-level agents for summarization, and then the summaries can be forwarded higher up the agent hierarchy. In other cases, instruction messages from higher level agents can be parsed to extract specific instructions for lower-level agents, and then the specific instructions can be provided to the appropriate agents.

Method 900 continues at block 910, where the application is controlled based on the behavior models. For instance, individual application APIs can be called to cause the agents to perform in-application behaviors as requested by the models.

### Additional Considerations

As noted above, lower-level agents can be implemented using reinforcement learning models instead of hard-coding. For instance, consider a mummy agent with a reward function that rewards the mummy with 1 point for any turn where a player does not collect a money prize and 1 point for every point of damage inflicted on a player. In this case, the mummy agents might exert a degree of autonomy in the gaming environment in certain turns where their respective ghost agents choose to not give them instructions. This can further reduce the bandwidth used in the application, because the ghost agent can expect the mummy agent to make its own independent decisions unless the ghost agent has a specific task for that mummy agent to accomplish.

In addition, the description above provided a relatively simple example to explain certain inventive concepts, using a game with a limited environment (a 10×10 grid) and simple game rules with a simple hierarchy, relatively few autonomous agents (7 monsters), and relatively few users (2 players). However, the disclosed techniques can be performed in a wide range of applications, ranging from local productivity applications to vast online games where thousands or more players participate in large virtual environments with thousands of autonomous agents (e.g., non-player characters).

In some cases, individual agents can be “promoted” to more computationally-intensive models at runtime. Consider a scenario where somewhat smaller generative models such as Phi-2, Mistral, or Nano-2 are initially responsible for specific regions of an application environment (e.g., 1,000,000 grid cells each). If one of those regions draws a lot of player interest at runtime, e.g., thousands of players move into a particular region, the agent responsible for that particular region can be promoted to a larger generative language model such as GPT, BLOOM, PaLM, and/or LLAMA. Likewise, that agent could be demoted from a larger model to a smaller model if many players moved out of its assigned region. As another example, if one or more players get close to a particular object (e.g., an important prize or objective), an agent responsible for protecting that prize could be promoted when the player reaches a threshold distance from the object. More generally, any time a change to the application environment is detected at runtime, the model assignments can be updated.

Some implementations can also consider explicit or implicit user feedback to configure a behavior model. For example, if users express explicit dissatisfaction with an application (e.g., by choosing a poor rating for the application) or implicit dissatisfaction (quitting after a short period of time, using language that suggests they are unhappy, etc.), this can be used a signal to adjust application behavior. For instance, the eye in the sky agent 302 could receive player telemetry that conveys explicit or implicit feedback and control the application experience accordingly. If players succeed at completing the game quickly, the eye in the sky agent could make the game more difficult by adding monsters, starting the players with lower health scores, etc. If players quit the game quickly without succeeding, the eye in the sky agent could make the game easier by removing monsters, starting the players with higher health scores, etc.

User feedback can also be employed by a behavior model to evaluate a current state of the application environment. For instance, if users appear dissatisfied with the appearance of a particular enemy or the inability to observe a problem (e.g., a hole in a fence allowing enemies to pass through), a behavior model (such as an eye in the sky) can adapt by altering the application environment at runtime to remove the enemy, repair the hole in the fence, etc. In some cases, reinforcement learning can be used to tune a generative language model by adapting to user feedback.

In some cases, generative language models can have a limited contextual memory. For instance, generative models often have input character limits, e.g., some generative models are limited to 4k, 8k, 32k, or 64k input characters. In some implementations, these contextual memory limits can be considered when configuring how telemetry is coordinated among agents. For instance, in some cases, a generative language model can be explicitly instructed to summarize received telemetry within a fixed size limit. For instance, given a 64k contextual memory limit of a superior agent and 64 subordinate agents that will report to the superior agent, each subordinate agent could be prompted with an instruction such as: “Summarize your received telemetry in 1k or fewer characters.” In further implementations, communications can be monitored at runtime and agents can be promoted to generative language models when the amount of telemetry they are receiving from subordinate agents exceeds the contextual memory limit of a currently-assigned model.

In addition, in some cases, behavior models utilize specific output formats at runtime. This can allow for efficient and accurate parsing of instruction messages. For instance, a generative language model can be instructed to use specific characters to delimit instructions for specific subordinate agents, e.g., “@ghost_1: move your team to the southwest sector and attack any players you observe, @ghost_2: move your team to the northeast sector and protect the money prizes in that sector.” This allows the agent coordinator 316 to consistently parse and identify the instructions for each respective subordinate agent.

In addition, note that the disclosed techniques can be implemented in both streaming application scenarios, local client-side application scenarios, or hybrids thereof. In some cases, relatively compact and resource-efficient models are selected for client-side execution, with larger models selected for server-side execution. This can be important for scenarios where certain agents (e.g., non-player characters that interact directly with players of an action-based video game) desirably exhibit low latency, e.g., by shooting, attacking, moving, defending, etc., very quickly. Other agents (e.g., non-player characters that control lower-level characters but do not directly interact with the players on-screen) can be implemented using higher latency models, where network communications to a server and perhaps several seconds worth of processing time do not negatively affect the user experience.

Furthermore, some implementations can employ multi-modal models. For instance, in some cases, a generative multi-modal model can receive, as input, images or audio from an application or data structures representing application state, with or without natural language input. From these inputs, the generative multi-modal model can generate images, audio, or data structures representing application state, with or without generating natural language output. Thus, for instance, a generative multi-modal model could receive an image output by an application together with a natural language instruction to control an agent based on the image, and the generative multi-modal model could output an application state data structure that conveys the next application state for the application, where the next application state involves a response by the agent to the input image. In other cases, generative multi-modal behavior models for different agents can communicate with each other via images, audio, and/or application state data structures instead of, or in addition to, natural language as described above.

In addition, in some cases, two or more models may be employed to control the behavior of a single agent. For instance, consider a scenario where the witch agent 308 uses a generative model to control and/or communicate with her subordinate agents, but also uses a reinforcement learning or hard-coded behavior model to control her own behavior. In some cases, the generative model could even be employed to confirm and, in some cases, even override the reinforcement learning and/or hard-coded agent.

Furthermore, some implementations can employ user data as context for agent behavior models. For instance, user profiles and/or features representing user preferences, skill levels, past experiences with a particular application, etc. can be input to a given agent behavior model to condition the decisions by that agent behavior model. In other implementations, users can be assigned to clusters based on their preferences, skill levels, past application experiences, etc., and the cluster that a given user belongs to can be input to an agent behavior model to condition that agent behavior model. In addition, other context features such as social networking features, vocal features, facial expressions, gestures, location, weather, lighting, background noise, application source or binary code, etc., can all be employed to condition agent behavior models.

### Device Implementations

As noted above with respect to FIG. 8, system 800 includes several devices, including a client device 810, a client device 820, a server 830, and a server 840. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 850. Without limitation, network(s) 850 can include one or more local area networks (LANs), wide area networks (WANs), the Internet, and the like.

### Additional Examples

Various examples are described above. Additional examples are described below. One example includes a computer-implemented method comprising accessing a hierarchy of agents for an application environment provided by an application, wherein the agents of the hierarchy interact in the application environment, assigning respective agent behavior models to individual agents based at least on respective levels of the individual agents in the hierarchy, configuring the respective agent behavior models based at least on one or more configuration parameters, coordinating communication among the respective agent behavior models during execution of the application, and controlling the application based at least on the respective agent behavior models.

Another example can include any of the above and/or below examples where the assigning the respective agent behavior models comprises determining resource utilization characteristics of the agent behavior models and selecting the respective agent behavior models for the agents based at least on the resource utilization characteristics and the respective levels of the agents in the hierarchy.

Another example can include any of the above and/or below examples where the respective agent behavior models include generative language models.

Another example can include any of the above and/or below examples where the respective agent behavior models include at least one of reinforcement learning models or hard-coded models.

Another example can include any of the above and/or below examples where the coordinating communication includes receiving two or more telemetry communications from two or more subordinate agents of a particular agent, prompting a particular generative language model assigned to the particular agent to generate a summary of the two or more telemetry communications, and sending the summary as a single communication to another generative language model assigned to another agent that is superior to the particular agent in the hierarchy.

Another example can include any of the above and/or below examples where the two or more telemetry communications relate to observations of the application environment by the two or more subordinate agents.

Another example can include any of the above and/or below examples where the two or more telemetry communications relate to status updates for the two or more subordinate agents

Another example can include any of the above and/or below examples where the coordinating communication includes receiving an instruction message output by a particular generative language model assigned to a particular agent, parsing the instruction message to identify a first instruction to a first subordinate agent of the particular agent and a second instruction to a second subordinate agent of the particular agent, and distributing the first instruction to a first agent behavior model of the first subordinate agent and the second instruction to a second agent behavior model of the second subordinate agent.

Another example can include any of the above and/or below examples where the coordinating communication includes prompting a particular generative language model of a particular agent with identifiers of one or more application programming interfaces of the application, receiving a message output by the particular generative language model, parsing the message to identify a particular application programming interface requested by the particular generative language model, and invoking the particular application programming interface on the application.

Another example can include any of the above and/or below examples where the message includes parameters for the particular application programming interface.

Another example can include any of the above and/or below examples where the feedback comprises explicit or implicit feedback relating to user satisfaction with the application.

Another example can include any of the above and/or below examples where the feedback relates to a current state of the application environment

Another example includes a system comprising a hardware processing unit and a storage resource storing computer-readable instructions which, when executed by the hardware processing unit, cause the system to coordinate communications among respective agent behavior models of agents of a hierarchy, wherein the agents of the hierarchy interact in an application environment provided by an application and the respective agent behavior models are assigned to the agents based at least on levels of individual agents in the hierarchy and resource utilization characteristics of the agent behavior models and control the application based at least on the respective agent behavior models.

Another example can include any of the above and/or below examples where the respective agent behavior models include generative models and at least one of reinforcement learning models or hard-coded models.

Another example can include any of the above and/or below examples where the computer-readable instructions, when executed by the hardware processing unit, cause the system to, at runtime, detect a change within the application environment and responsive to detecting the change to within the application environment, promote a particular agent from a particular reinforcement learning or hard-coded model to a particular generative model.

Another example can include any of the above and/or below examples where the change relates to movement of the particular agent toward a particular object in the application environment.

Another example can include any of the above and/or below examples where the respective agent behavior models is executed on at least two different computing devices.

Another example includes a computer-readable storage medium storing computer-readable instructions which, when executed by a processing unit, cause the processing unit to perform acts comprising accessing a hierarchy of agents for an application environment provided by an application, wherein the agents of the hierarchy interact in the application environment and respective agent behavior models are assigned to individual agents based at least on respective levels of the individual agents in the hierarchy and resource utilization characteristics of the respective agent behavior models, configuring the respective agent behavior models based at least on one or more configuration parameters, coordinating communication among the respective agent behavior models during execution of the application, and controlling the application based at least on the respective agent behavior models.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
accessing a hierarchy of agents for an application environment provided by an application, wherein the agents of the hierarchy interact in the application environment;
assigning respective agent behavior models to individual agents based at least on respective levels of the individual agents in the hierarchy;
configuring the respective agent behavior models based at least on one or more configuration parameters;
coordinating communication among the respective agent behavior models during execution of the application; and
controlling the application based at least on the respective agent behavior models.

2. The computer-implemented method of claim 1, wherein the assigning the respective agent behavior models comprises:
determining resource utilization characteristics of the agent behavior models; and
selecting the respective agent behavior models for the agents based at least on the resource utilization characteristics and the respective levels of the agents in the hierarchy.

3. The computer-implemented method of claim 2, wherein the respective agent behavior models include generative language models.

4. The computer-implemented method of claim 3, wherein the respective agent behavior models include at least one of reinforcement learning models or hard-coded models.

5. The computer-implemented method of claim 3, wherein the coordinating communication includes:
receiving two or more telemetry communications from two or more subordinate agents of a particular agent;
prompting a particular generative language model assigned to the particular agent to generate a summary of the two or more telemetry communications; and
sending the summary as a single communication to another generative language model assigned to another agent that is superior to the particular agent in the hierarchy.

6. The computer-implemented method of claim 5, the two or more telemetry communications relating to observations of the application environment by the two or more subordinate agents.

7. The computer-implemented method of claim 5, the two or more telemetry communications relating to locations of the two or more subordinate agents in the application environment.

8. The computer-implemented method of claim 5, the two or more telemetry communications relating to status updates for the two or more subordinate agents.

9. The computer-implemented method of claim 3, wherein the coordinating communication includes:
receiving an instruction message output by a particular generative language model assigned to a particular agent;
parsing the instruction message to identify a first instruction to a first subordinate agent of the particular agent and a second instruction to a second subordinate agent of the particular agent; and
distributing the first instruction to a first agent behavior model of the first subordinate agent and the second instruction to a second agent behavior model of the second subordinate agent.

10. The computer-implemented method of claim 3, wherein the coordinating communication includes:
prompting a particular generative language model of a particular agent with identifiers of one or more application programming interfaces of the application;
receiving a message output by the particular generative language model;
parsing the message to identify a particular application programming interface requested by the particular generative language model; and
invoking the particular application programming interface on the application.

11. The computer-implemented method of claim 10, the message including parameters for the particular application programming interface.

12. The computer-implemented method of claim 1, further comprising receiving feedback from users and providing the feedback to a particular agent behavior model of a particular agent with a request that the particular agent adjust the application environment based on the feedback.

13. The computer-implemented method of claim 12, the feedback comprising explicit or implicit feedback relating to user satisfaction with the application.

14. The computer-implemented method of claim 12, the feedback relating to a current state of the application environment.

15. A system comprising:
a hardware processing unit; and
a storage resource storing computer-readable instructions which, when executed by the hardware processing unit, cause the system to:
coordinate communications among respective agent behavior models of agents of a hierarchy, wherein the agents of the hierarchy interact in an application environment provided by an application and the respective agent behavior models are assigned to the agents based at least on levels of individual agents in the hierarchy and resource utilization characteristics of the agent behavior models; and
control the application based at least on the respective agent behavior models.

16. The system of claim 15, wherein the respective agent behavior models include generative models and at least one of reinforcement learning models or hard-coded models.

17. The system of claim 16, wherein the computer-readable instructions, when executed by the hardware processing unit, cause the system to:
at runtime, detect a change within the application environment; and
responsive to detecting the change to within the application environment, promote a particular agent from a particular reinforcement learning or hard-coded model to a particular generative model.

18. The system of claim 17, the change relating to movement of the particular agent toward a particular object in the application environment.

19. The system of claim 15, the respective agent behavior models being executed on at least two different computing devices.

20. A computer-readable storage medium storing computer-readable instructions which, when executed by a processing unit, cause the processing unit to perform acts comprising:
accessing a hierarchy of agents for an application environment provided by an application, wherein the agents of the hierarchy interact in the application environment and respective agent behavior models are assigned to individual agents based at least on respective levels of the individual agents in the hierarchy and resource utilization characteristics of the respective agent behavior models;
configuring the respective agent behavior models based at least on one or more configuration parameters;
coordinating communication among the respective agent behavior models during execution of the application; and
controlling the application based at least on the respective agent behavior models.
